(19) United States
(12) Patent Application Publication
(10) Pub. No.: US 2004/0262913 A1
(43) Pub. Date: Dec. 30, 2004

(54) Security device for sewer line

(76) Inventors: Bobby John Anderson, Greensboro, NC (US); Percy Clark Morgan JR., Greensboro, NC (US)

Correspondence Address: COATS & BENNETT, PLLC, P O BOX 5, RALEIGH, NC, 27602, US

(21) Appl. No.: 10/606,044

(22) Filed: Jun. 25, 2003

(51) Int. Cl. F16L 3/00

(52) U.S. Cl. 285/61

(57) ABSTRACT

The present invention provides a securing device for securing the sewer drain line of a recreational vehicle during use. The securing device comprises a hold-down member that passes over the top of the sewer drain line and has opposing ends secured to the ground.

### FIELD OF THE INVENTION

The present invention relates generally to sewage disposal for recreational vehicles and, more particularly, to a security strap for an RV sewer line.

### BACKGROUND OF THE INVENTION

Recreational vehicles (RVs) are often equipped with holding tanks for waste that can be connected with sewage systems at campgrounds. A sewer drain line connects the holding tank in the RV to an inlet pipe for the campground sewage system. The inlet pipe for the campground sewage system typically extends a few inches out of the ground, and one end of the sewer drain line inserts into the sewer inlet. Once connected, the sewer drain line allows waste in the holding tank of the RV to be drained into the campground sewer system.

During drainage of the holding tank, back pressure may sometimes push the end of the sewer drain line out of the sewer inlet causing sewage to be spilled on the ground. Any experienced camper knows that sewage spills are both unpleasant and unsanitary and require cleanup. Because no reliable and convenient method exists to solve this problem, campers have resorted to crude methods to secure the sewer drain line in place, such as by weighting the sewer drain line with rocks.

U.S. Pat. No. 4,587,994 to Links et al. discloses one device for securing a sewer drain line. The '994 patent discloses a stopper for an inlet pipe to a campground sewer system to close off the inlet when not in use. The stopper includes a cylindrical plate that is placed over the inlet of the sewer line and a pin. The pin may be used to secure the sewer drain line within the sewer inlet by inserting the pin through two holes in the sewer inlet. The pin passes between corrugations on the sewer drain line to secure the sewer drain line within the sewer inlet.

The sewer line securing device disclosed by the '994 patent has some significant disadvantages. In particular, the securing device disclosed in the '994 patent requires specially designed sewer inlets which are not universally available. Thus, the solution proposed in the '994 patent has only limited utility.

Accordingly, there remains a need for a reliable and inexpensive method for securing a sewer drain line that can be applied universally to any type of sewer hook-up.

### BRIEF SUMMARY OF THE INVENTION

The present invention provides a securing device for securing a sewer drain line for a recreational vehicle during use to prevent unintentional spillage of sewage. In its broadest terms, the present invention comprises a hold-down device that passes over the top of the sewer drain line and has first and second ends that secure to the ground on either side of the sewer drain line. The hold-down device may, for example, comprise a flexible strap having grommets at each end thereof. Ground stakes may be inserted through the grommets at either end of the flexible strap to secure the flexible strap to the ground. In another embodiment, the hold-down device comprises a U-shaped wicket having a pair of legs connected by a cross-member. The wicket is inserted into the ground with the legs on opposing sides of the sewer inlet and the cross-member passing over the top of the sewer drain line.

### BRIEF DESCRIPTION OF THE DRAWINGS

FIG. 1 is a perspective view illustrating a first embodiment of a sewer line securing device according to the present invention.

FIG. 2 is a plan view of the hold-down member for the first embodiment of the securing device.

FIG. 3 is a side elevational view of a ground penetrating member for the first embodiment of the securing device.

FIG. 4 illustrates an alternative design for the hold-down member for the first embodiment of the securing device.

FIG. 5 is a perspective view of a second embodiment of the sewer line securing device according to the present invention.

FIG. 6 is a side elevational view of a hold-down member for a second embodiment of the securing device.

FIG. 7 is a perspective view of the first embodiment of the securing device being used with an optional hold-down block.

FIG. 8 is a front view of a hold-down block that may be used with the first embodiment of the sewer line securing device.

FIG. 9 is an end view showing the hold-down block.

FIG. 10 is a front view of a second embodiment of the hold-down block for use with the first embodiment of the securing device.

FIG. 11 is an end view of a second embodiment of the hold-down block.

FIG. 12 is a front view of a third embodiment of the hold-down block for use with the second embodiment of the securing device.

### DETAILED DESCRIPTION OF THE INVENTION

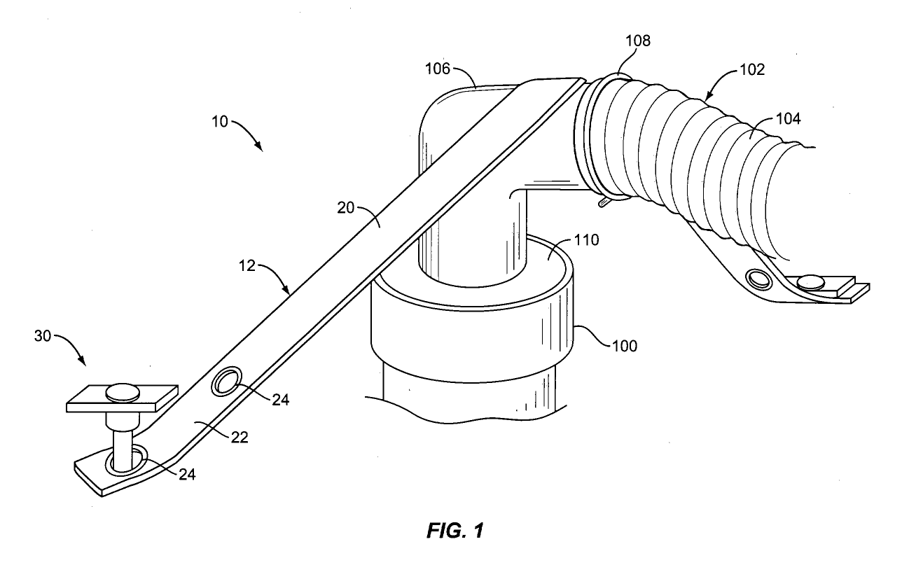

Referring now to the drawings, and particularly to FIG. 1, a sewer line securing device is shown therein and indicated generally by the numeral 10. The securing device is used to secure a sewer drain line 102 within a sewer inlet 100. The sewer drain line 102 comprises a flexible hose 104 connected to an elbow 106 by a hose clamp 108. The elbow 106 fits into the sewer inlet 100. The sewer inlet 100 may be fitted with a donut-shaped foam insert 110 to provide a tight seal between the elbow 106 and sewer inlet 100.

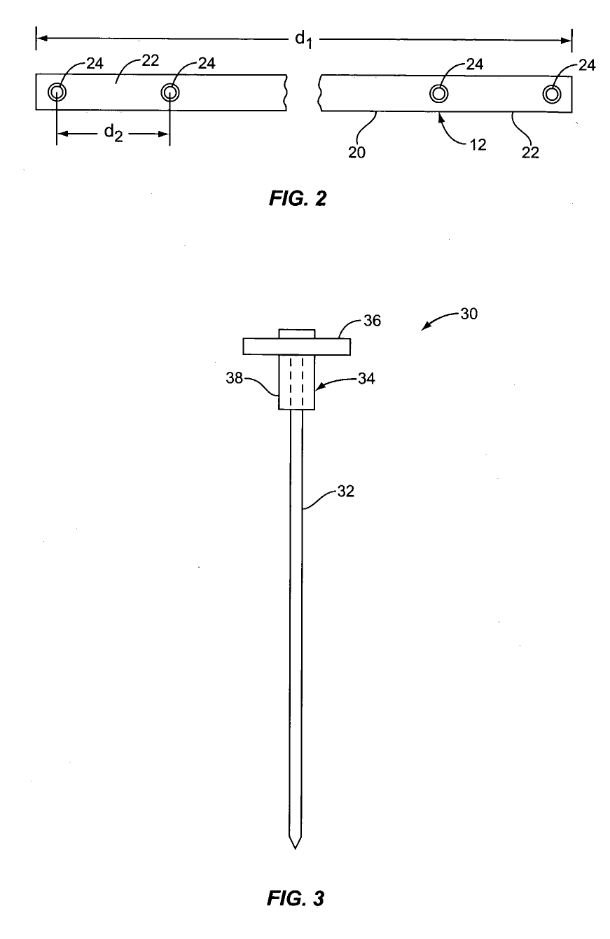

The sewer line securing device 10 of the present invention comprises a hold-down member 12 that passes over the top of the sewer drain line 102 and attaches to the ground on opposing sides of the sewer inlet 100. In the embodiment shown in FIG. 1, the hold-down member 12 comprises a flexible strap 20 having first and second ends 22. Each end 22 of the flexible strap 20 includes at least one grommet or eyelet 24. In a preferred embodiment of the invention, the flexible strap 20 includes two or more longitudinally-spaced grommets 24. The flexible strap 20 has an overall length, denoted d₁ in FIG. 2, of approximately thirty-six inches and has two grommets 24 at each end spaced a distance, denoted d₂, of approximately six inches apart. The flexible strap 20 may be made of a variety of materials, including nylon weaving, leather, plastic, or metal.

Ground penetrating members 30 secure the ends 22 of the flexible strap 20 to the ground. An exemplary ground-penetrating member 30 is shown in FIG. 3. The ground-penetrating member 30 comprises a metal stake 32 having a point at one end thereof and a plastic end cap 34 at the opposite end. The plastic end cap 34 is formed with finger holds 36 to facilitate insertion and removal of the stake 32 into and out of the ground. The end cap 34 includes an opening 38 through which the ground stake 32 passes. The head of the ground stake engages the top of the end cap 34.

To use the securing device 10 of the present invention, the sewer drain line 102 is first inserted into the sewer inlet 100. Once the sewer drain line 102 is in place, the flexible strap 20 is placed over the top of the sewer drain line 102 with the ends 22 on opposite sides of the sewer inlet 100. A first end 22 of the flexible strap 20 is secured in place by inserting a ground penetrating member 30 through one of the grommets 24 and driving the ground penetrating member 30 into the ground. After securing the first end to the ground, the user pulls the flexible strap 20 tight to apply a downward force to the sewer drain line 102 and secures the second end 24 of the flexible strap 20 to the ground using a second ground penetrating member 30. With proper tension, the flexible strap 20 will hold the sewer drain line 102 in place and prevent the back pressure from pushing the sewer drain line 102 out of the sewer inlet 100.

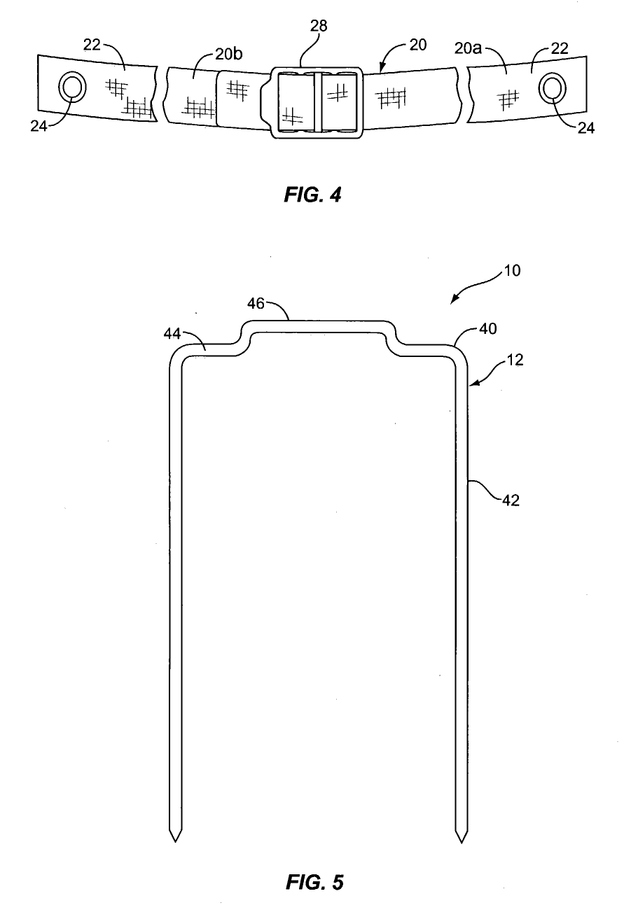

In the embodiment shown in FIGS. 1-3, the flexible strap 20 has a fixed length. FIG. 4 illustrates an alternate embodiment of the flexible strap 20 that is adjustable in length. In the embodiment shown in FIG. 4, the flexible strap 20 comprises two sections 20a, 20b. Section 20a has a conventional buckle 28 secured at one end thereof. One end of section 20b passes through the buckle 28 and loops back. Because the length of the flexible strap 20 is adjustable, there is need for only a single grommet 24 at each end 22 of the flexible strap 20.

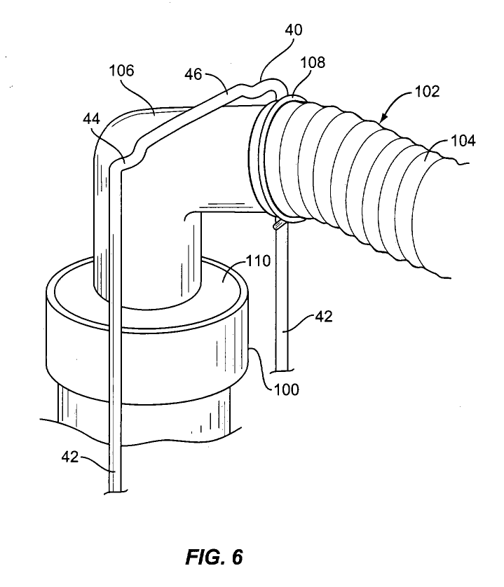

FIGS. 5 and 6 illustrate a second embodiment of the securing device 10 of the present invention. In the second embodiment, the hold-down member 12 comprises a wicket 40 that can be driven or pressed into the ground. Wicket 40 comprises a pair of legs 42 which are sharpened into points at the bottom end and are connected at the top end by a cross member 44. Cross member 44 may include a raised section 46 which serves as a grip or handle.

To use the embodiment shown in FIGS. 5 and 6, the sewer drain line 102 is first inserted into the sewer inlet 100. The wicket 40 is then positioned over the top of the sewer drain line 102 with the legs 42 disposed on opposing sides of the sewer inlet 100 and the cross member 44 passing over the top of the sewer drain line 102. The wicket 40 is then pressed or driven into the ground until the cross member 44 engages the sewer drain line 102.

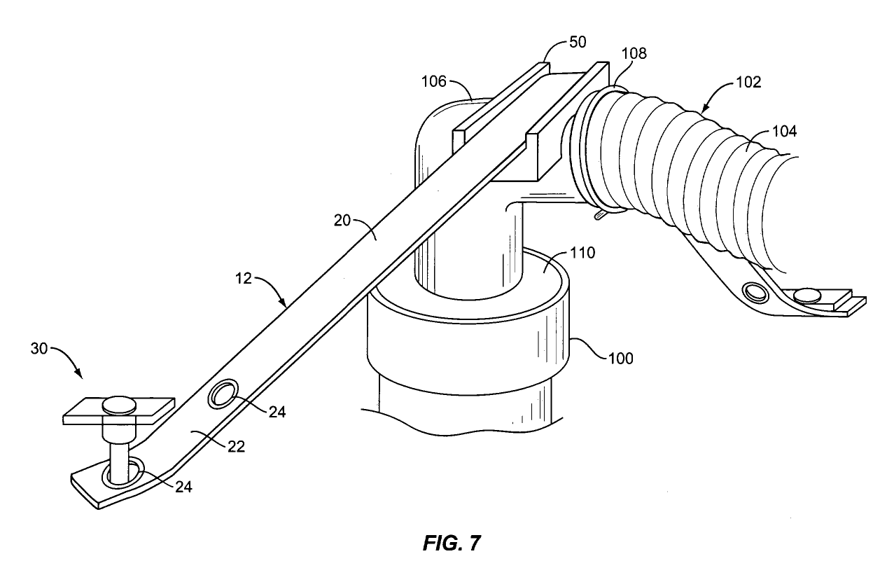

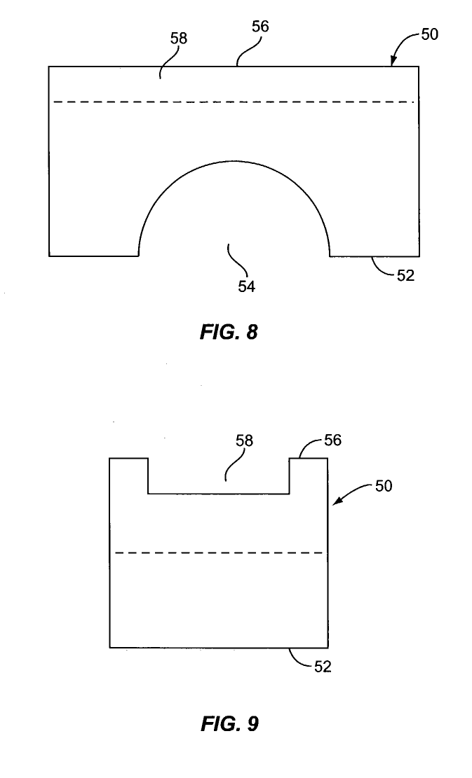

FIG. 7 illustrates the first embodiment of the securing device 10 of the present invention being used with an optional hold-down block 50. The hold-down block 50 is interposed between the flexible strap 20 and the sewer drain line 102. The hold-down block 50 is shown in more detail in FIGS. 8 and 9. Hold-down block 50 includes a bottom surface 52 having arcuate-shaped recess 54 that conforms to the shape of the sewer drain line 102. The top surface 56 of the hold-down block 50 includes a channel 58 that extends the length of the hold-down block 50. The channel 58 has a width approximately equal to the width of the flexible strap 20. The flexible strap 20 passes through the channel 58 and the tension on the flexible strap 20 holds the hold-down block 50 in place. The hold-down block 50 can be made of a variety of materials, including plastic, rubber, wood, or metal. The hold-down block 50 preferably provides a relatively high coefficient of friction to prevent the flexible strap 20 from slipping off of the sewer drain line 102.

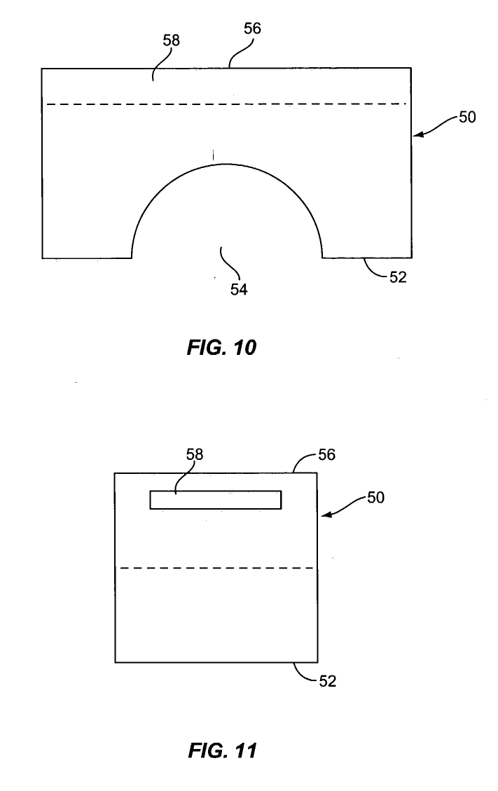

FIGS. 10 and 11 illustrate an alternate embodiment of the hold-down block 50. In the embodiment shown in FIGS. 10 and 11, the channel 58 is closed on top to form a slot that passes length-wise through the hold-down block 50. One advantage of the hold-down block 50 shown in FIGS. 10 and 11 is that it will remain on the flexible strap 20 when the securing device 10 is not in use. This feature prevents separation of the hold-down block 50 from the flexible strap 20.

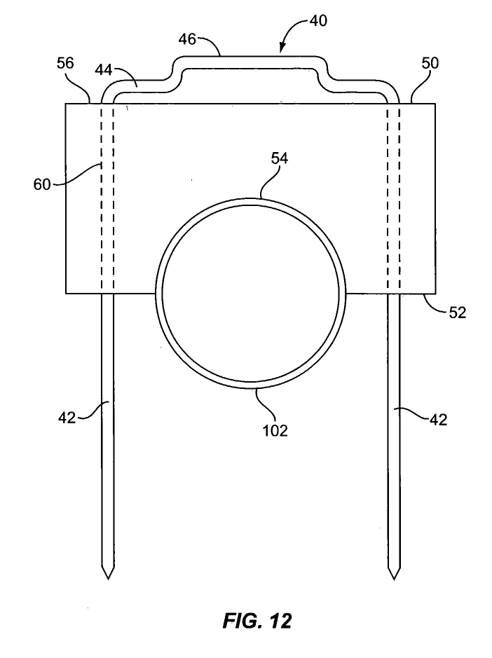

FIG. 12 illustrates a third embodiment of the hold-down block 50 for use with the second embodiment of the securing device shown in FIGS. 5 and 6. This embodiment of the hold-down block 50 includes a bottom surface 52 with an arcuate recess 54 and a top surface 56. Leg holes 60 extend vertically through the hold-down block 50 from the top surface 56 to the bottom surface 52. The leg holes 60 are disposed on opposing sides of the arcuate recess 54 and are spaced by an amount corresponding to the distance between the legs 42 of the wicket.

Several exemplary embodiments of the invention have been described herein. Those skilled in the art will recognize that the present invention is not limited to the specific embodiments disclosed.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A securing device for securing a sewer drain line for a recreational vehicle in a sewer inlet, said securing device comprising:
a) a hold-down member that passes over the top of the sewer drain line and applies a downward force to the sewer drain line;
b) said hold-down member comprising a flexible strap having first and second ends that secure to the ground on opposing sides of said sewer inlet;
c) ground penetrating members to secure said first and second ends of said flexible strap to the ground; and
d) wherein said flexible strap includes at least two longitudinally spaced grommets in said first and second ends to receive said ground penetrating members.

2-4. (Cancelled).

5. The securing device of claim 1 wherein said ground penetrating members comprise ground stakes adapted to pass through said grommets in said first and second ends of said flexible strap.

6. (Cancelled)

7. The securing device of claim 1 wherein said flexible strap is adjustable in length.

8. The securing device of claim 1 further comprising a hold-down block interposed between said hold-down member and said sewer drain line.

9. The securing device of claim 8 wherein said hold-down block comprises a surface shaped to conform to said sewer drain line.

10. The securing device of claim 9 wherein said hold-down block further comprises a channel through which said flexible strap passes.

11. The securing device of claim 9 wherein said channel comprises a slot passing transversely through said hold-down block.

12.-17. (Cancelled)

18. The securing device of claim 8 wherein said hold-down block includes at least one opening through which said hold-down member extends.

19. A method of securing a sewer drain line for a recreational vehicle within a sewer inlet, said method comprising:
a) passing a hold-down member over the top of said sewer drain line, said hold-down member comprising a flexible strap having opposing ends;
b) securing said opposing ends of said hold-down member to the ground on opposing sides of said sewer inlet such that said hold-down member applies a downward securing force to said sewer drain line; and
c) wherein said flexible strap includes at least two longitudinally spaced grommets at each said opposing end and is secured to the ground by ground stakes passing through said grommets.

20-22. (Cancelled).
